(19) United States
(12) Patent Application Publication
(10) Pub. No.: US 2013/0170231 A1
(43) Pub. Date: Jul. 4, 2013

(54) SPHERICAL LIGHT BULB AND HEAT DISSIPATING DEVICE THEREOF

(71) Applicant: HUA-JUNG CHIU, TAOYUAN COUNTY (TW)

(72) Inventor: HUA-JUNG CHIU, TAOYUAN COUNTY (TW)

(73) Assignee: DAVINCI INDUSTRIAL INC., NEW TAIPEI CITY (TW)

(21) Appl. No.: 13/342,911

(22) Filed: Jan. 3, 2012

(51) Int. Cl. F21V 3/02; F21V 29/00

(52) U.S. Cl. 362/363; 362/373

(57) ABSTRACT

A spherical light bulb including a connector, a driver module, a heat dissipating device, a light source unit and a transparent light cover. The heat dissipating device includes a barrel-shaped member, a plurality of heat dissipating fins, a supporting member arranged on one end of the barrel-shaped member, and a connecting portion connected to the heat dissipating fins and arranged around the supporting member. The supporting member has a supporting surface and a heat dissipating channel in communication with the inner space defined by the barrel-shaped member. A slot is formed concavely on the inner surface of the barrel-shaped member in communication with a plurality of gaps formed between the heat-dissipating fins. The light source unit is arranged on the supporting surface. The transparent light cover is secured to the connecting portion and accommodates the supporting member. The instant disclosure further includes the aforementioned heat dissipating device.

### BACKGROUND OF THE INVENTION

1. Field of the Invention

The instant disclosure relates to a spherical light bulb and a heat dissipating device arranged thereon; in particular, to a spherical light bulb which utilizes the light-emitting diode (LED) as the light source.

2. Description of Related Art

Nowadays, LEDs have been applied widely on spherical light bulbs, and majority of the spherical light bulbs include a screw-like connector, a heat dissipating device, and a transparent light cover. In order to dissipate heat efficiently, the heat dissipating device of conventional LED spherical light bulbs generally occupies a large portion of the spherical light bulb. In other words, through observing from the side view, the central portion of the spherical light bulb is mostly occupied by the heat dissipating device, leaving only a relatively smaller portion for the transparent light cover. This kind of design lead to the semispherical-shaped transparent light cover in most of the commonly-seen LED spherical light bulbs, meanwhile narrowing the illumination angle thereof.

Through the study of the aforementioned LED spherical light bulbs, two existing problems are discovered; firstly, the transparent light cover is too small and the illumination angle of light is too narrow, and the key point to overcome the first problem is to find a cooperating heat dissipating device, and this refers to the second problem. In other words, the heat dissipating efficiency of the heat dissipating device has to be improved to reduce the height ratio so as to increase the illumination angle.

To address the above issue, the inventor strives via industrial experience and academic research to present the instant disclosure, which can effectively improve the limitation described above.

### SUMMARY OF THE INVENTION

The object of the instant disclosure is to provide a spherical light bulb. Through the cooperation of the improved heat dissipating device and the transparent light cover, the illumination angle of the light bulb can be increased. In addition, the instant disclosure provides a heat dissipating device for the spherical light bulb, where the heat dissipating structure is modified to enhance the heat dissipating efficiency of the spherical light bulb.

In order to achieve the aforementioned objects, according to an embodiment of the instant disclosure, a spherical light bulb is provided, which includes a connector, a driver module, a heat dissipating device, a light source unit, and a transparent light cover. The driver module includes a driver which is electrically connected to the connector. The heat dissipating device includes: a barrel-shaped member; a plurality of heat dissipating fins; a supporting member; and a connecting portion. The heat dissipating fins protrude outward from the outer surface of the barrel-shaped member, and the supporting member is arranged on one end of the barrel-shaped member. Moreover, the connecting portion is arranged around the supporting member and connected to the heat dissipating fins. In addition, the supporting member has a supporting surface, and a heat dissipating channel in communication with the inner space defined by the barrel-shaped member and the supporting surface, and the driver is arranged inside the barrel-shaped member. A slot is concaved outward from the inner surface of the barrel-shaped member in communication with a plurality of gaps formed between the heat-dissipating fins. Thereby, each gap is enabled to communicate with the heat-dissipating channel. The light source unit is arranged on the supporting surface of the supporting member. The transparent light cover is substantially spherical-shaped having an opening formed thereon. The transparent light cover is fixed to the connecting portion through a flanged portion around the opening, where the supporting member passes through the opening and is arranged inside the transparent light cover.

In order to achieve the aforementioned objects, according to an embodiment of the instant disclosure, a heat dissipating device which is connected to the transparent light cover of the spherical light bulb is provided. The heat dissipating device includes: a barrel-shaped member; a plurality of heat dissipating fins; a supporting member; and a connecting portion. The heat dissipating fins protrude outward from the outer surface of the barrel-shaped member, and the supporting member is arranged on one end of the barrel-shaped member. Moreover, the connecting portion is arranged around the supporting member and connected to the heat dissipating fins. In addition, the supporting member has a supporting surface and a heat dissipating channel in communication with the inner space defined by the barrel-shaped member and the supporting surface. The connecting portion is connected to a flanged portion of the transparent light cover.

The instant disclosure has the following advantages: the supporting member passes through the opening of the transparent light cover in providing a wider illumination angle; in comparison to conventional heat dissipating structures, the instant disclosure further provides a method of convective heat transfer; and heat produced by the light source unit can not only be transmitted to the heat dissipating fins from the supporting member, but also from the heat dissipating channel and the slot, thereby, the heat dissipating efficiency of the heat dissipating device is enhanced by utilizing the method of convection to vent the residual heat.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows an exploded view of a spherical light bulb in accordance with the instant disclosure;

FIG. 2 shows another exploded view of the spherical light bulb in accordance with the instant disclosure;

FIG. 3 shows an assembled view of the spherical light bulb in accordance with the instant disclosure;

FIG. 4 shows an isometric cross-sectional view of a heat-dissipating device of the spherical light bulb in accordance with the instant disclosure; and

FIG. 5 shows a cross-sectional view of the spherical light bulb in accordance with the instant disclosure.

### DETAILED DESCRIPTION OF THE EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

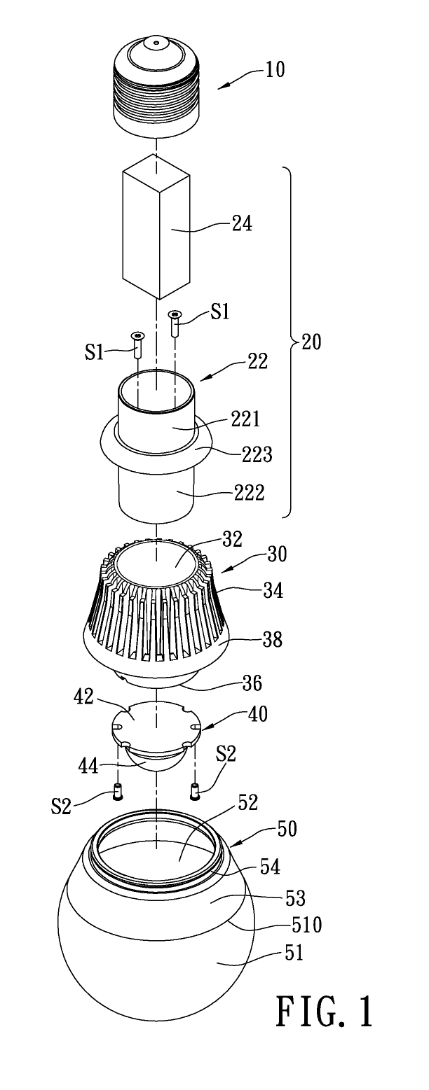

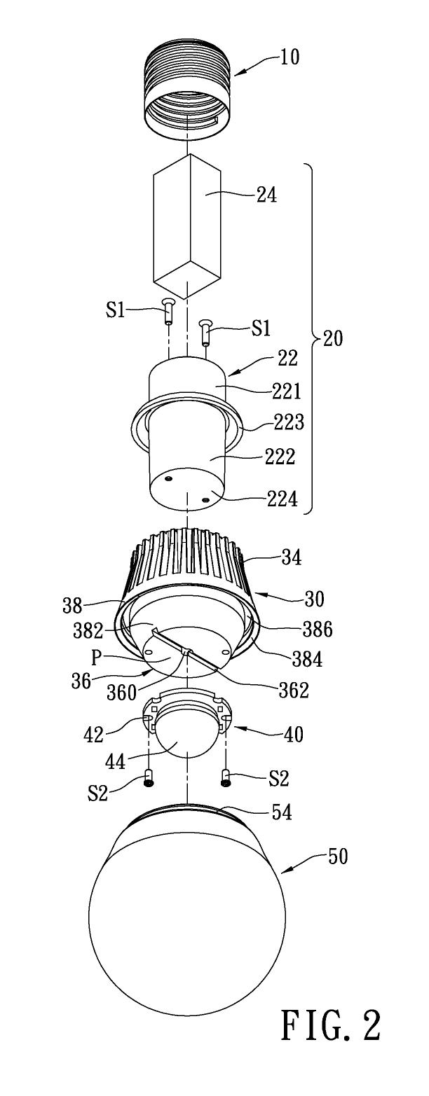

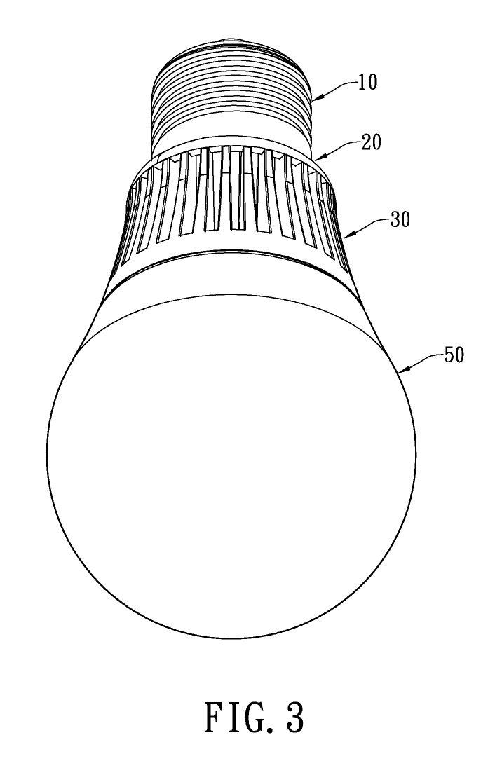

Please refer to FIGS. 1 and 2, which show two exploded views of a spherical light bulb in accordance with the instant disclosure. The spherical light bulb of the instant disclosure includes a connector 10, a driver module 20, a heat dissipating device 30, a light source unit 40, and a transparent light cover 50. The connector 10 is an E27 screw connector in the instant embodiment, however this is not restricted thereto. The driver module 20 includes an outer housing 22 and a driver 24 arranged therein. The heat dissipating device 30 is arranged between the connector 10 and the light source unit 40, and is preferably made with good heat dissipating materials such as aluminum, copper and so on. The transparent light cover 50 is fixed on the heat dissipating device 30 while enclosing the light source unit 40. For reference, the assembled view of the spherical light bulb is shown in FIG. 3.

Referring again to FIGS. 1 and 2. The heat dissipating device 30 includes: a barrel-shaped member 32; a plurality of heat dissipating fins 34; a supporting member 36; and a connecting portion 38. The heat dissipating fins 34 protrude outward from the outer surface of the barrel-shaped member 32, and the supporting member 36 is arranged on one end of the barrel-shaped member 32. Moreover, the connecting portion 38 is arranged around the supporting member 36 and connected to the heat dissipating fins 34. In addition, the supporting member 36 has a supporting surface P and a heat dissipating channel 360. The heat dissipating channel 360 is in communication with the inner space defined by the barrel-shaped member 32 and the supporting surface P. The driver 24 is arranged in the barrel-shaped member 32.

The driver module 20 is arranged between the connector 10 and the heat dissipating device 30. The driver 24 is connected electrically to the connector 10 to convert the power from the connector 10 into electrical power suitable for the light source unit 40. One end of the outer housing 22, shown with the orientation in the figures, is defined as an upper end portion 221 fixed to the connector 10, while the other end of the outer housing 22, shown with the orientation in the figures, is defined as a lower end portion 222 secured inside the barrel-shaped member 32. A blocking member 223 is formed centrally on the surface of the outer housing 22, abutting the barrel-shaped member 32 and the heat dissipating fins 34 of the heat dissipating device 30. Furthermore, the outer housing 22 of the instant embodiment has a base surface 224 defined on the base section of the lower end portion 222, and the base surface 224 is fixed to the supporting member 36 of the heat dissipating device 30 through screws S1.

The light source unit 40 is arranged on the supporting surface P of the supporting member 36. The light source unit 40 of the instant embodiment includes a substrate 42 arranged against the supporting surface P and a converging lens 44. An LED is arranged on the substrate 42 as the light source, and the substrate 42 can be either a metal or a ceramic substrate. The area of the substrate 42 of the instant embodiment is substantially equivalent to the area of the supporting surface P, and the substrate 42 is fixed to the supporting member 36 by using screws S2.

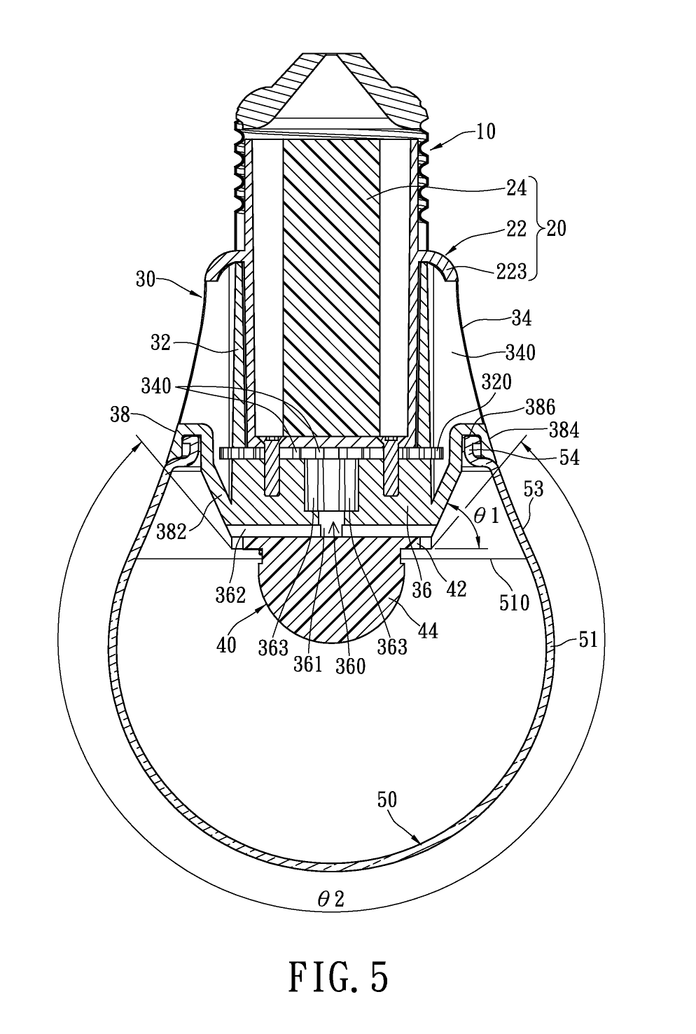

The transparent light cover 50 of the instant disclosure is specially designed. Two thirds of the transparent light cover 50 is a spherical housing 51, and a transitional housing 53 is connected thereto. A transition loop line 510 is defined between the spherical housing 51 and the transitional housing 53. An opening 52 is formed on the edge of the transitional housing 53 of the transparent light cover 50. A flanged portion 54 is arranged around the opening 52 of the transparent light cover 50 for securing to the connecting portion 38 of the heat dissipating device 30. The aforementioned design enables the instant disclosure to acquire a greater illumination angle. Through the design of the aforementioned supporting member 36 and the connecting portion 38, the instant embodiment can provide an illumination angle of 285 degrees. Further illustrations of the structural arrangements shall be provided in FIG. 5.

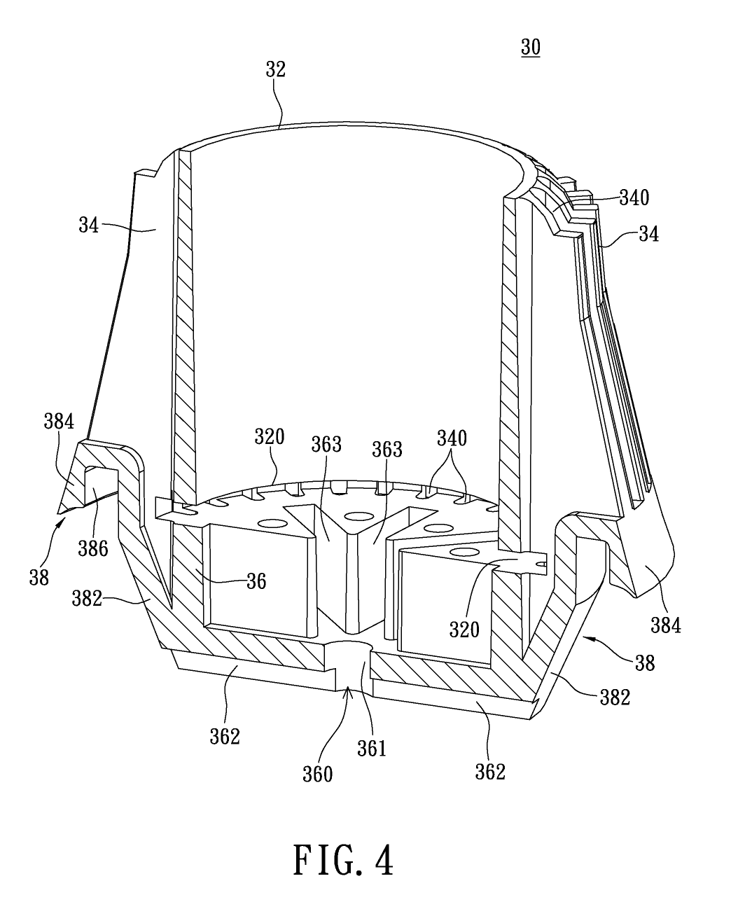

Another feature of the instant disclosure is that the structure of the heat dissipating device is improved to enhance the heat dissipating efficiency of the spherical light bulb. Please refer to FIG. 4 for a cross-sectional view of the heat dissipating device of the spherical light bulb in accordance with the instant disclosure. The heat dissipating device 30 includes a slot 320 which concaves outward from the inner surface of the barrel-shaped member 32. The slot 320 communicates with a plurality of gaps 340 formed between the heat dissipating fins 34. In other words, the barrel-shaped member 32 of the instant embodiment is in communication with the root portions (or base portions) of the heat dissipating fins by cutting a trough from the inner surface of the barrel-shaped member 32. Thereby, enabling the gaps 340 between the heat dissipating fins 34 to communicate with a heat dissipating channel 360 formed centrally on the supporting member 36. In comparison to conventional heat dissipating structures which only utilize the method of conduction and radiation for heat transfer, the instant disclosure further provides a method of convective heat transfer. The heat produced by the light source unit 40 can be conducted to the heat dissipating fins 34 from the supporting member 36, while the remaining heat can also be released through the heat dissipating channel 360 and the slot 320 by convection.

Notably, the heat dissipating channel 360 of the instant embodiment is defined by a central hole 361 and a plurality of extended troughs 363 in communication therewith. The central hole 361 is projected through the central portion of the supporting member 36 and concaves from the supporting surface P. The supporting member 36 has an inner surface defined inside the barrel-shaped member 32 opposite of the supporting surface P. In other words, the extended troughs 363 are formed concavely on the inner surface. The extended troughs 363 of the instant embodiment are radially arranged toward the slot 320. In other words, the extended troughs 363 extend toward the gaps 340 between the heat dissipating fins 34. Thus, such design enhances heat convection.

Furthermore, the supporting member 36 of the instant embodiment further has a passageway 362 concavely formed on the supporting surface P. The passageway 362 communicates with the heat dissipating channel 360. At least one passageway 362 is provided. By utilizing the passageway 362, air can flow between the base portion of the light source unit 40 and the supporting member 36 to form a convection path from inside the transparent light cover 50 to the outside of the heat dissipating device 30.

Referring to FIG. 4 again, where detailed descriptions of the connecting portion 38 of the instant embodiment is introduced in the following. The heat dissipating fins 34 are expanding gradually from the opening of the barrel-shaped member 32 toward the supporting member 36. Based on the orientation shown in the figure, the width of the heat dissipating fins 34 increases gradually from the top toward the bottom. The connecting portion 38 has a wedged annular wall 382 and an indented member 384 around the barrel-shaped member 32. The indented member 384 is connected to the wedged annular wall 382 and the heat dissipating fins 34. The indented member 384 is defined by an annular groove 386 formed thereon facing toward the wedged annular wall 382 for securing the flanged portion 54 of the transparent light cover 50.

Referring to FIG. 5, which shows a cross-sectional view of the spherical light bulb in accordance with the instant disclosure. The supporting member 36 is passed through the opening 52 of the transparent light cover 50 and arranged therein. The angle θ1 between the wedged annular wall 382 of the connecting portion 38 and the imaginary plane extending from the supporting surface P is greater than an angle of 52.5 degrees, or relative to the imaginary plane extending from the substrate 42 of the light source unit 40. This angular configuration allows light emitting from the light source unit 40 to project slantingly toward the heat dissipating device 30. From the side view, the base surface of the converging lens 44 of the light source unit 40 is approximately arranged at the same elevation with the transitional loop line 510 of the transparent light cover 50. In other words, the base surface of the converging lens 44 is arranged on the virtual plane formed by the transitional loop line 510. Thereby, light passing through the converging lens 44 can be projected on the entire spherical housing 51 and even onto the transitional housing 53. Generally, the emitted light can be projected on the entire transparent light cover 50 including the spherical housing 51 and the transitional housing 53 with an illumination angle of 285 degrees.

Based on the above, the advantages of the instant disclosure are that the supporting member 36 is passed through the opening 52 of the transparent light cover 50 and arranged therein. In addition, two thirds of the transparent light cover 50 is approximately the spherical housing 51, thereby providing a larger illumination angle. Furthermore, in comparison to conventional heat dissipating structures, the instant disclosure further provides a method of convective heat transfer. Heat produced by the light source unit 40 can not only be transmitted to the heat dissipating fins 34 through the supporting member 36, but also be dissipated through the heat dissipating channel 360 and the slot 320 by convection.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A spherical light bulb, comprising:
a connector;
a driver module including a driver electrically connected to the connector;
a heat dissipating device including a barrel-shaped member, a plurality of heat dissipating fins protruding from the barrel-shaped member, a supporting member arranged on one end of the barrel-shaped member, and a connecting portion arranged around the supporting member and adjoined to the heat dissipating fins, wherein the supporting member has a supporting surface and a heat dissipating channel formed therein in communication with the inside of the barrel-shaped member and the supporting surface, wherein the driver is arranged in the barrel-shaped member, wherein a slot is concavely formed on the inner surface of the barrel-shaped member in communication with a plurality of gaps formed between the heat dissipating fins, whereby allowing the gaps between the heat dissipating fins to communicate with the heat dissipating channel;
a light source unit arranged on the supporting surface of the supporting member; and
a substantially spherical-shaped transparent light cover having an opening formed thereon, wherein the transparent light cover has a flanged portion around the opening for securing to the connecting portion, wherein the supporting member passes through the opening and is arranged inside the transparent light cover.

2. The spherical light bulb according to claim 1, wherein the heat dissipating channel is defined by a central hole and a plurality of extended troughs in communication therewith, wherein the central hole is formed on the central portion of the supporting member and concavely on the supporting surface, wherein the supporting member has an inner surface inside the barrel-shaped member opposite of the supporting surface, and wherein the extended troughs are formed concavely on the inner surface of the supporting member toward the gaps.

3. The spherical light bulb according to claim 1, wherein the supporting member further includes at least one passageway formed concavely on the supporting surface in communication with the heat dissipating channel.

4. The spherical light bulb according to claim 1, wherein the heat dissipating fins expand gradually from the opening of the barrel-shaped member toward the supporting member, wherein the connecting portion has a wedged annular wall and an indented member, wherein the indented member is arranged around the barrel-shaped member, and wherein the indented member connects to the wedged annular wall and the heat dissipating fins.

5. The spherical light bulb according to claim 4, wherein the angle between the wedged annular wall of the connecting portion and the imaginary plane extending from the supporting surface is greater than 52.5 degrees.

6. The spherical light bulb according to claim 1, wherein the light source unit includes a substrate arranged on the supporting surface and a converging lens arranged on the substrate, wherein the transparent light cover has a spherical housing and a transitional housing connected thereto, wherein a transitional loop line is defined between the spherical housing and the transitional housing, and wherein the base surface of the converging lens is approximately at the same elevation with the transitional loop line.

7. A heat dissipating device, connected to a transparent light cover of the spherical light bulb, comprising:
a barrel-shaped member;
a plurality of heat dissipating fins extending from the barrel-shaped member;
a supporting member arranged on one end of the barrel-shaped member;
a connecting portion arranged around the supporting member and connected to the heat-dissipating fins, wherein the supporting member has a supporting surface and a heat dissipating channel in communication with the inside of the barrel-shaped member and the supporting surface, and wherein the connecting portion is secured to a flanged portion of the transparent light cover.

8. The heat dissipating device according to claim 7, wherein the heat dissipating channel is defined by a central hole and a plurality of extended troughs in communication therewith, wherein the central hole is formed on the central portion of the supporting member and concavely on the supporting surface, wherein the supporting member has an inner surface inside the barrel-shaped member opposite of the supporting surface, and wherein the extended troughs are formed concavely on the inner surface of the supporting member toward the heat dissipating fins.

9. The heat dissipating device according to claim 8, wherein the supporting member further has at least one passageway concavely formed on the supporting surface, and wherein the passageway is in communication with the heat dissipating channel.
